(19) United States
(12) Patent Application Publication
(10) Pub. No.: US 2026/0200263 A1
(43) Pub. Date: Jul. 16, 2026

(54) Rim for Motor Vehicle

(71) Applicant: Dr. Ing. h.c. F. Porsche Aktiengesellschaft, Stuttgart (DE)

(72) Inventor: Maximilian Clauer, Weissach (DE)

(73) Assignee: Dr. Ing. h.c. F. Porsche Aktiengesellschaft, Stuttgart (DE)

(21) Appl. No.: 19/444,317

(22) Filed: Jan. 9, 2026

(30) Foreign Application Priority Data
Jan. 10, 2025 (DE) 10 2025 100 771.3

(51) Int. Cl. B60B 3/10; B60B 3/02; B60B 7/06

(52) U.S. Cl. CPC B60B 3/10; B60B 3/02; B60B 7/065; B60B 2360/104; B60B 2360/106; B60B 2360/3416; B60B 2900/1216

(57) ABSTRACT

A rim for a motor vehicle for optimizing the aerodynamic drag of the motor vehicle. The rim includes a rim bed for securely seating a tire on the rim, a base structure including a hub ring for improving the rolling performance of the rim, spokes arranged between hub ring and rim bed, and at least two accommodating cavities each having at least one cover element accommodated therein to form an at least partially closed base structure.

### CROSS-REFERENCE TO RELATED APPLICATION

This application claims priority to German Patent Application No. 10 2025 100 771.3, filed January 10, 2025, the content of such application being incorporated by reference herein in its entirety.

### FIELD OF THE INVENTION

The invention relates to a rim (i.e., wheel) for a motor vehicle.

### SUMMARY OF THE INVENTION

Rims (wheels) for vehicles generally have an open structure and are designed to accommodate tires for vehicles. Vehicles can include passenger cars, trucks, motorcycles, or other motorized and non-motorized vehicles. Rims play a crucial role in the functioning of vehicles, as they not only secure and support the tires, but also contribute to driving stability, weight reduction, energy efficiency, and the design of the vehicle. Rims contribute significantly to stability and safety by evenly distributing the vehicle’s load onto the tires and dampening vibrations while driving. Rims in the prior art are disadvantageously designed with an open structure. An open structure, for example, offers less protection against the ingress of dirt, water, or other foreign objects that can be entrained while driving. This can not only affect the service life of the rim and adjacent components, but also have a negative impact on functionality and maintenance costs. Furthermore, the open structure can have aerodynamic disadvantages since air turbulence is created, which increases air resistance and thus reduces the vehicle’s energy efficiency.

Described herein is a rim that optimizes the energy efficiency and aerodynamics of a vehicle and at least partially overcomes at least one of the disadvantages described above.

Further features and details of the invention arise from the dependent claims, the description, and the drawings. The features and details described in connection with the rim according to aspects of the invention naturally also apply in connection with the vehicle according to aspects of the invention and vice versa, so that mutual reference is or can be made to the disclosure of the individual aspects of the invention.

The invention relates to a rim for a motor vehicle for optimizing the aerodynamic drag of the motor vehicle, comprising a rim bed for secure seating of a tire on the rim, a base structure for stabilizing the rim, the base structure comprising a hub ring to improve the rolling performance of the rim, spokes, wherein the spokes are arranged between the hub ring and the rim bed, at least two accommodating cavities, each of which accommodates at least one cover element to form an at least partially closed base structure.

A motor vehicle within the meaning of the invention can be understood to mean passenger cars (cars), trucks, motorcycles, or other motorized and non-motorized vehicles. Air resistance can be optimized if the aerodynamic properties of the rim are designed to minimize air resistance while retaining the desired functions and characteristics. The rim bed can be understood as the region where a tire is arranged. In particular, the rim bed may also comprise the rim flange. In other words, the entire width of the rim can form the rim bed.

The base structure can stabilize the rim. The base structure can comprise several components. The base structure comprises at least one hub ring, spokes, and at least two accommodating cavities. The hub ring is a ring-shaped element that can be positioned in the center of the base structure. The hub ring can improve the rolling performance of a rim. The spokes can extend radially from the hub ring. In other words, the spokes can be arranged vertically on the hub ring. The other end of the spoke can be mechanically connected to the rim bed. Spokes can be round, oval, square, or rectangular in shape. The cross-section can vary along the length of the spoke; for example, the spoke can have a larger cross-section in the region of the wheel hub and a smaller cross-section at the rim bed. It may be provided that the spokes protrude vertically, in particular at an angle of 90 degrees from the hub ring. However, it may also be envisaged that the angle differs from 90 degrees and that several, at least two, spokes intersect. At least two, preferably ten spokes may be provided. Crossing at least two spokes has the advantage that forces can be dissipated particularly well.

Furthermore, the base structure has at least two accommodating cavities, each of which accommodates at least one cover element in order to form an at least partially closed base structure. In the context of the invention, an accommodating cavity can be understood to mean a specifically designed hollow space or mold within the rim that serves to accommodate a cover element. In particular, the accommodating cavity can be designed to be closed in four directions. If the accommodating cavity is not closed with a cover element, the base structure is open.

Within the scope of the invention, it may be advantageous for the base structure to have a central ring that delimits the accommodating cavity in the direction of the hub ring. The central ring can be arranged between the hub ring and the rim bed. In other words, the central ring can divide the base structure, in particular the spokes, into two regions: a region from the hub ring to the central ring and a region from the central ring to the hub ring. The hub ring can be ring-shaped, wherein the hub ring can be circular or approximately round with a central cavity. The hub ring can have the same depth as the spokes. The hub ring can form one side of the accommodating cavity. A central ring has the advantage of stabilizing the rolling performance of a rim.

Within the scope of the invention, it is conceivable that the spokes each have a first and a second region, wherein the first region of the spoke extends from the hub ring to the central ring and the second region of the spoke extends from the central ring to the rim bed, wherein the second region of the spoke, which runs between the central ring and the rim bed, delimits the accommodating cavity. In other words, the central ring can divide a respective spoke into a first region and a second region. The first region can be considered to be the region formed between the hub ring and the central ring. The second region can be considered to be the region extending between the central ring and the rim bed. The second region of a spoke can delimit one side of an accommodating cavity. An accommodating cavity can be delimited on two sides by a second region of a spoke. A fastening region may be provided on each spoke, on which a cover element can be arranged. Dividing the spoke into two regions has the advantage that the cover elements can be attached in a particularly secure manner.

It may be provided within the scope of the invention that the accommodating cavity is delimited on the side opposite the central ring by the rim bed. The accommodating cavity can have four sides. The first side may be delimited by the central ring. The second side, especially the side opposite the central ring, can be delimited by the rim bed. The third and fourth sides can each be delimited by a second region of a spoke. The third and fourth sides can establish a mechanical connection between the first and second sides. The accommodating cavity may have fastening regions for snapping in a cover element. The fastening regions may have locking tabs. The locking tabs can be flexible elements that deform when a cover element is clicked into place and then return to their original position to secure the cover element. In addition, these locking lugs can be equipped with projections that ensure a form-fitting connection. Grooves may also be provided for guiding and positioning the cover element. The grooves enable the cover element to snap securely into place in the accommodating cavity. Alternatively or additionally, introductory ramps may be provided to facilitate the insertion and, in particular, the snapping into place of a cover element. For this purpose, the edge of at least one side of the accommodating cavity may be slanted or rounded to allow smooth guidance of the cover element. Furthermore, elastic elements can be integrated into the sides of the accommodating cavity to compensate for manufacturing tolerances and prevent movement, in particular rattling of the cover element.

It is also conceivable that the spoke, in particular the second region of the spoke, is curved. The curvature of a spoke can be achieved in different ways. An S-shaped curvature may be provided, which distributes mechanical stresses evenly along the spoke and allows for better adaptation to complex geometries. Alternatively, a V-shaped curve can be formed with sharp angles, which is particularly robust and saves space without compromising stability. An arched curvature that describes part of a circle can ensure even load distribution and high durability under dynamic loads. It may be provided that both regions of the spoke describe a circular path together or that only the second region of the spoke forms a circular path. It may be provided that the spokes are connected to each other in a form-fitting manner by a hub ring radially on the inside and a central ring radially between the hub ring and the rim bed and on the rim bed radially on the outside.

It is also conceivable that the second region of the spoke is arranged tangentially to the rim bed. The second region can describe, in particular, a quarter of a circular path of a closed circle. The second region can be continuously connected to the first region on one side and connected tangentially or snugly to the rim bed in the region of the rim bed. This design is particularly aerodynamic.

Within the scope of the invention, it is optionally possible for the cover element to be accommodated in the accommodating cavity by form-fit and/or force-fit. The cover element can be designed so that it forms the positive or negative part of the accommodating cavity. Furthermore, the form-fitting connection can be achieved by means of precisely shaped locking tabs, grooves, or protrusions, which enable a precise fit between the cover element and the accommodating cavity. The cover element can be designed to fit precisely into the accommodating cavity. The cover element may have a stable but slightly flexible structure in order to adapt to the fastening regions when clicked into place and to compensate for mechanical stresses. It may also have guide ridges or indentations that correspond in particular to grooves in the accommodating cavity in order to ensure precise alignment. Furthermore, the surface of the cover element can be smooth or have specific structures to ensure a secure seal and prevent the ingress of dirt or moisture. The cover element may comprise hooks to provide a connection with at least one of the four sides of the accommodating cavity. Alternatively or additionally, the force-fit connection can be formed by elastic materials or clamping mechanisms which ensure that the cover element is held firmly in the accommodating cavity by friction or pressure.

Furthermore, the invention may provide that the cover element comprises a carbon fiber composite material. The cover element can be designed as a monolithic molded part with high strength. The cover element may also be designed as a woven or braided molded part. Such a molded part is particularly shock-resistant. Carbon fiber composite material is extremely light, but has high tensile and compressive strength.

With regard to the present invention, it is conceivable that the base structure is at least 10%, preferably 30%, closed. If no cover element is arranged to the rim, the base structure, in particular the surface, is 0% closed. The more closed the rim is, the better its aerodynamic properties, but on the other hand, heat dissipation properties deteriorate, especially from the brakes. Therefore, a base structure that is at least 10%, preferably 30%, closed appears especially advantageous. The rim can be closed using cover elements that are attached to the accommodating cavities. The cover elements can cover at least 10%, preferably 20%, and particularly preferably 50% of the rim.

Furthermore, it is conceivable that the base structure and the rim bed are designed to be monolithic and/or made of a uniform material. The hub ring, the central ring, the spokes, and the rim bed can be designed as a single piece and/or made of a uniform material. This has the advantage that the rim is particularly resistant to mechanical impact.

Within the scope of the invention, it may be advantageous for the base structure to comprise a light metal, in particular aluminum or magnesium. The light metal can be anodized and/or powder-coated, making the rim particularly durable. Light metals offer a good combination of low weight and high strength, making them well suited for rims. The low mass resulting from the use of light metals and/or fiber composites leads to lower mass and inertia, which improves the acceleration capacity of the vehicle with rims according to aspects of the invention. In addition, the unsprung mass is reduced, which in particular leads to improved lateral dynamics of the vehicle with rims according to aspects of the invention.

Within the scope of the invention, it is conceivable that the rim further comprises a rim hub, wherein a support structure is provided between the rim hub and the hub ring. The rim hub may be suitable for connecting the rim to a motor vehicle. A support structure is provided between the rim hub and the hub ring. The support structure can be a mechanically load-bearing connection between the hub ring and the rim hub. The support structure can be wrapped with a fiber composite material using a direct wet wrapping method and bonded in a materially bonded manner, wherein the fiber composite material preferably comprises carbon fibers and a matrix, in particular made of epoxy resin. The rim hub can be pressed into the central ring and connected in a force-fit manner. The support structure enables a particularly advantageous rolling performance of the rim.

It may be envisaged within the scope of the invention that the support structure comprises a fiber composite material. Fiber composite material is particularly lightweight with high strength and is therefore well suited for use as a structural element in a rim.

A rim according to aspects of the invention can also be referred to as an aero rim. Aero rims are specially designed rims whose aerodynamic shape helps to reduce the vehicle’s air resistance and thus improve efficiency.

This results in the same advantages for a vehicle according to aspects of the invention as those already described for a rim according to aspects of the invention.

### BRIEF DESCRIPTION OF THE DRAWINGS

Further advantages, features, and details of the invention are apparent from the following description, in which several example embodiments of the invention are described in detail with reference to the drawings. The features mentioned in the claims and in the description can be essential to the invention individually or in any combination. In the drawings:

FIG. 1 depicts a perspective view of a rim,

FIG. 2 depicts a front and side view of a rim, and

FIG. 3 depicts the first and second regions of a spoke.

### DETAILED DESCRIPTION OF THE INVENTION

In the following figures, identical reference symbols are used for the same technical features, even in different example embodiments.

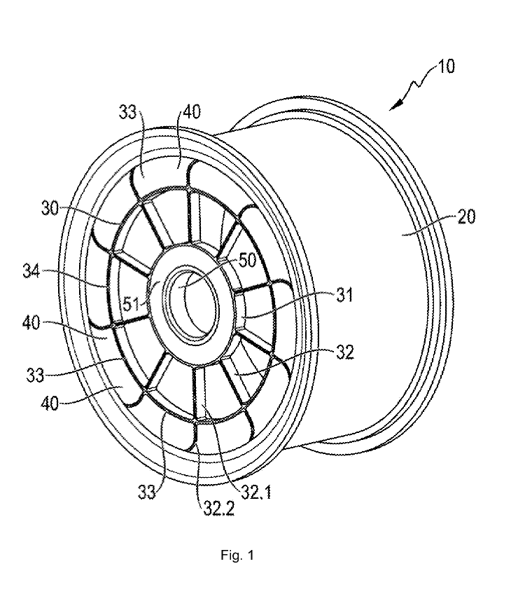

FIG. 1 shows a perspective view of a rim 10 for a motor vehicle for optimizing the air resistance of the motor vehicle, comprising a rim bed 20 for securely seating a tire on the rim 10, a base structure 30 for stabilizing the rim 10, the base structure 30 having a hub ring 31 to improve the rolling performance of the rim 10, spokes 32, the spokes 32 being arranged between the hub ring 31 and the rim bed 20, and at least two accommodating cavities 33, each of which accommodates at least one cover element 40 to form an at least partially closed base structure 30. The rim 10 also has a central ring 34 which delimits the accommodating cavity 33 in the direction of the hub ring 31.

The spokes 32 each have a first 32.1 and a second region 32.2, wherein the first region 32.1 of the spoke 32 extends from the hub ring 31 to the central ring 34 and the second region 32.2 of the spoke 32 extends from the central ring 34 to the rim bed 20, wherein the second region 32.2 of the spoke 32, which runs between the central ring 34 and the rim bed 20, delimits the accommodating cavity 33.

The accommodating cavity 33 is delimited on the side opposite the central ring 34 by the rim bed 20. The second region 32.2 of the spoke 32 is curved, with the second region 32.2 of the spoke 32 arranged tangentially to the rim bed 20.

The cover element 40 is accommodated in the accommodating cavity 33 by form and force, wherein the cover element 40 comprises a carbon fiber composite material. The base structure 30 is closed by the cover elements 40 by at least 10%, preferably 30%.

The base structure 30 and the rim bed 20 are monolithic and made of a single material. The base structure 30 comprises a light metal, in particular aluminum or magnesium.

The rim 10 comprises a rim hub 50, wherein a support structure 51 is provided between the rim hub 50 and the hub ring 31, wherein the support structure 51 comprises a fiber composite material.

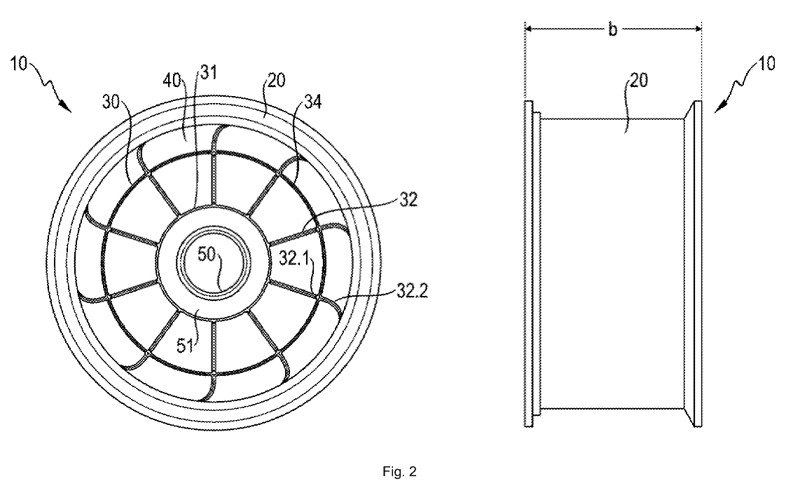

FIG. 2 shows a front and side view of a rim 10. It is disclosed that the accommodating cavity 33 is delimited on four sides. On the first side, the accommodating cavity 33 is delimited by the central ring 34. On the side opposite the central ring 34, the accommodating cavity 33 is delimited by the rim bed 20. On the third and fourth sides, the accommodating cavity 33 is delimited by the second region 32.2 of a spoke 32. The cover elements 40 are designed so that they are arranged in the accommodating cavity 33 in a form-fitting and/or force-fitting manner.

The width “b” of the rim bed 20 extends across the entire width “b” of the rim 10; in particular, the rim bed 20 may also comprise the rim flange. The rim 10 has a total of ten spokes 32 and ten separate accommodating cavities 33. The first region 32.1 of spoke 32 merges smoothly into the second region 32.2 of spoke 32, wherein the second region 32.2 of spoke 32 describes a circular arc, in particular a quarter of a circular arc. The second region 32.2 of the spoke 32 connects tangentially to the rim bed 20.

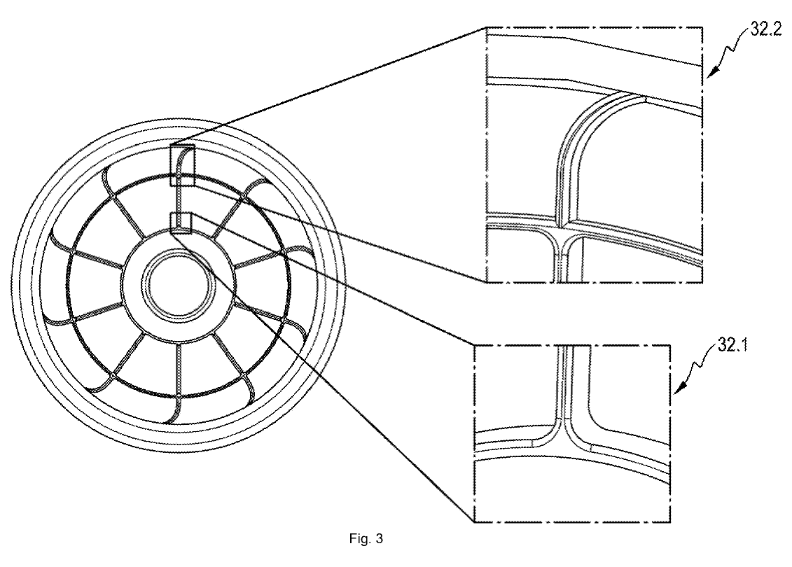

FIG. 3 shows an enlargement of the first 32.1 and second regions 32.2 of a spoke 32. The first region 32.1 of the spoke 32 protrudes vertically from the hub ring 31 and merges smoothly into the second region 32.2 of the spoke 32. The second region 32.2 of the spoke 32 is arranged tangentially to the rim bed 20. The base structure 30 and the rim bed 20 are monolithic and made of a single material.

What is claimed is:

1. A rim for a motor vehicle for optimizing an aerodynamic drag of the motor vehicle, said rim comprising:
(a) a rim bed for seating a tire on the rim,
(b) a base structure for stabilizing the rim, the base structure comprising:
(i) a hub ring,(ii) spokes arranged between the hub ring and the rim bed, and(iii) at least two accommodating cavities each having at least one cover element accommodated therein to form an at least partially closed base structure.

2. The rim according to claim 1, wherein the base structure has a central ring which delimits the accommodating cavities in a direction of the hub ring.

3. The rim according to claim 2, wherein each accommodating cavity is delimited on a side opposite the central ring by the rim bed.

4. The rim according to claim 3, wherein the spokes each comprise a first region and a second region, wherein the first region of each spoke extends from the hub ring to the central ring and the second region of each spoke extends from the central ring to the rim bed.

5. The rim according to claim 4, wherein the second region of the spoke is curved.

6. The rim according to claim 4, wherein the second region of the spoke is arranged tangentially to the rim bed.

7. The rim according to claim 1, wherein each cover element is accommodated in one of the accommodating cavities in a form-fitting and/or force-fitting manner.

8. The rim according to claim 1, wherein each cover element comprises a carbon fiber composite material.

9. The rim according to claim 1, wherein the base structure is at least 10 percent closed.

10. The rim according to claim 1, wherein the base structure and the rim bed are monolithic.

11. The rim according to claim 1, wherein the base structure and the rim bed are composed of a same material.

12. The rim according to claim 1, wherein the base structure comprises aluminum or magnesium.

13. The rim according to claim 1, wherein the rim further comprises a rim hub and a support structure disposed between the rim hub and the hub ring.

14. The rim according to claim 13, wherein the support structure comprises a fiber composite material.

15. A vehicle comprising the rim according to claim 1.
